(19) United States
(12) Patent Application Publication
(10) Pub. No.: US 2019/0349560 A1
(43) Pub. Date: Nov. 14, 2019

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yuri Yoshimura, Yokohama-shi (JP)

(21) Appl. No.: 16/389,819

(22) Filed: Apr. 19, 2019

(30) Foreign Application Priority Data
May 9, 2018 (JP) 2018-090314

(51) Int. Cl. H04N 13/117; H04N 13/167; H04N 5/247; H04N 5/232; G06K 9/32

(52) U.S. Cl. CPC H04N 13/117; H04N 13/167; G06K 9/3241; H04N 5/23219; H04N 5/247

(57) ABSTRACT

An information processing apparatus includes an information processing apparatus includes an obtaining unit configured to obtain viewpoint information regarding virtual viewpoints corresponding to virtual viewpoint images generated based on a plurality of captured images obtained by a plurality of imaging apparatuses performing image capturing from a plurality of directions, a detection unit configured to detect an object included in at least any of the plurality of captured images and included in a field of view corresponding to a virtual viewpoint identified based on the viewpoint information obtained by the obtaining unit, and an output unit configured to, based on a detection result of the detection unit associated with a plurality of virtual viewpoints identified based on the viewpoint information obtained by the obtaining unit, output information associated with the number of virtual viewpoints of which the fields of view include a same object.

### BACKGROUND

### Field of the Disclosure

The present disclosure relates to a virtual viewpoint image to be generated based on a plurality of captured images obtained with a plurality of imaging apparatuses.

### Description of the Related Art

There is a technique for performing synchronous imaging from multiple viewpoints with a plurality of imaging apparatuses (cameras) installed at different positions and generating not only images captured from the installation positions of the imaging apparatuses, but also a virtual viewpoint image of which the viewpoints can be optionally changed, using a plurality of images obtained through the synchronous imaging. The virtual viewpoint image is generated by an image processing unit, such as a server, aggregating the images captured by the plurality of imaging apparatuses, generating a three-dimensional model, and performing a rendering process. The generated virtual viewpoint image is then transmitted to a user terminal for viewing.

For example, a virtual viewpoint image corresponding to viewpoints set by a user is generated from images obtained by capturing a sport, whereby the user can watch a game from the user's desired viewpoints. Japanese Patent Application Laid-Open No. 2014-215828 discusses a technique in which sharing virtual viewpoints specified by a user with other users enables the user to view a virtual viewpoint image with feeling of a sense of unity with the other users. Japanese Patent Application Laid-Open No. 2014-215828 further discusses a technique for displaying information for determining (identifying) virtual viewpoints specified by many users.

For example, in a virtual viewpoint image to be generated from images obtained by image capturing of a sport, if a scene or an object (e.g., a player) as an attention target to which a user has a high degree of attention can be determined, it is possible to use the virtual viewpoint image for various uses, such as the creation of a highlight image that satisfies many users. However, even if information for determining virtual viewpoints specified by many users at a certain time is obtained with the technique discussed in Japanese Patent Application Laid-Open No. 2014-215828, it is not easy to determine a scene or an object as an attention target from the information. A similar issue lies not only in a case where a sport is a viewing target regarding the virtual viewpoint image, but also in a case where another event, such as a concert, is a viewing target regarding the virtual viewpoint image.

### SUMMARY

According to one or more aspects of the present disclosure, an information processing apparatus includes an obtaining unit configured to obtain viewpoint information regarding virtual viewpoints corresponding to virtual viewpoint images generated based on a plurality of captured images obtained by a plurality of imaging apparatuses performing image capturing from a plurality of directions, a detection unit configured to detect an object included in at least any of the plurality of captured images and included in a field of view corresponding to a virtual viewpoint identified based on the viewpoint information obtained by the obtaining unit, and an output unit configured to, based on a detection result of the detection unit associated with a plurality of virtual viewpoints identified based on the viewpoint information obtained by the obtaining unit, output information associated with the number of virtual viewpoints of which the fields of view include a same object.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an image processing system according to one or more aspects of the present disclosure.

FIG. 2 is a perspective view illustrating an example where a plurality of virtual cameras is set according to one or more aspects of the present disclosure.

FIG. 3 is a bird's-eye view illustrating an example where the plurality of virtual cameras is set according to one or more aspects of the present disclosure.

FIG. 4 is a flowchart illustrating processing regarding an analysis of virtual camera information and generation of presentation information by using an information processing apparatus according to one or more aspects of the present disclosure.

FIG. 5 is a diagram illustrating an example of presentation of an analysis result of the virtual camera information according to one or more aspects of the present disclosure.

FIG. 6 is a perspective view illustrating an example where a plurality of virtual cameras is set according to one or more aspects of the present disclosure.

FIG. 7 is a bird's-eye view illustrating an example where the plurality of virtual cameras is set.

FIG. 8 is a flowchart illustrating processing regarding an analysis of virtual camera information and generation of presentation information by using the information processing apparatus according to one or more aspects of the present disclosure.

FIG. 9 is a diagram illustrating an example of an analysis result of the virtual camera information according to one or more aspects of the present disclosure.

FIGS. 10A and 10B are diagrams each illustrating an example of presentation of an analysis result of the virtual camera information according to one or more aspects of the present disclosure.

FIG. 11 is a flowchart illustrating processing regarding generation of a highlight image by using the information processing apparatus according to one or more aspects of the present disclosure.

FIG. 12 is a diagram illustrating an example of a hardware configuration of the information processing apparatus according to one or more aspects of the present disclosure.

### DESCRIPTION OF THE EMBODIMENTS

Exemplary embodiments of the present disclosure will be described in detail below with reference to the accompanying drawings. The present disclosure, however, is not limited to these exemplary embodiments, but can be modified and changed in various manners within the scope of the present disclosure described in the appended claims.

### [Configuration of Image Processing System]

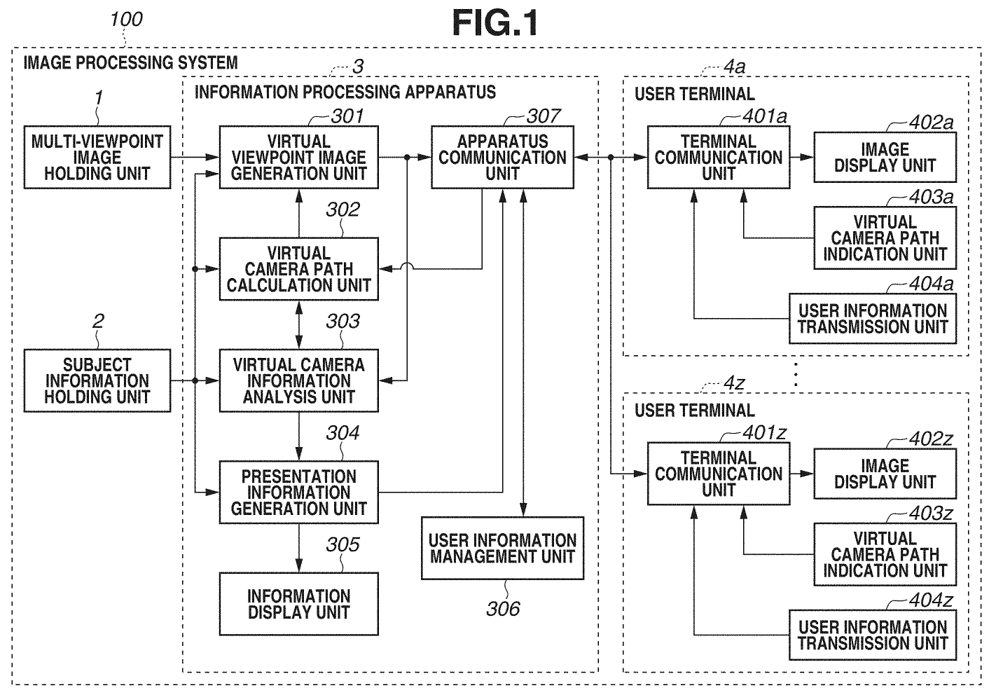

FIG. 1 is a diagram illustrating the overall configuration of an image processing system 100 according to an exemplary embodiment of the present disclosure. The image processing system 100 is a system for, based on images obtained through imaging with a plurality of imaging apparatuses and specified virtual viewpoints, generating a virtual viewpoint image representing fields of view from the specified virtual viewpoints. The virtual viewpoint image according to the present exemplary embodiment is also referred to as a free viewpoint video. The virtual viewpoint image, however, is not limited to an image corresponding to viewpoints freely (optionally) specified by a user. Examples of the virtual viewpoint image also include an image corresponding to viewpoints selected from among a plurality of candidates by the user. In the present exemplary embodiment, a case is mainly described where the virtual viewpoints are specified by a user operation. Alternatively, the virtual viewpoints may be automatically specified by the image processing system 100 based on the result of an image analysis. In the present exemplary embodiment, a case is mainly described where the virtual viewpoint image is a moving image. Alternatively, the virtual viewpoint image to be processed by the image processing system 100 may be a still image.

The image processing system 100 includes a multi-viewpoint image holding unit 1 (hereinafter, an “image holding unit 1”), a subject information holding unit 2 (hereinafter, an “information holding unit 2”), an information processing apparatus 3, and user terminals 4a to 4z. In FIG. 1, as examples, the 26 user terminals 4a to 4z are connected to the information processing apparatus 3. However, the number of user terminals connected to the information processing apparatus 3 is not limited to this. Hereinafter, unless otherwise described, the 26 user terminals 4a to 4z will be referred to as “user terminals 4” with no distinction. Similarly, unless otherwise described, function units in each user terminal 4 will also be referred to as a “terminal communication unit 401”, an “image display unit 402”, a “virtual camera path indication unit 403” (hereinafter, a “path indication unit 403”), and a “user information transmission unit 404” with no distinction.

The image holding unit 1 holds images (multi-viewpoint images) obtained by an imaging target area being imaged from a plurality of different directions using a plurality of imaging apparatuses. The imaging target area includes a predetermined object (foreground object), for example, a singer, an instrument player, an actor, and a stage set, or a player and a ball in the case of a sport. The plurality of imaging apparatuses are installed around the imaging target area and perform synchronous imaging. That is, at least any of a plurality of captured images to be obtained by the plurality of imaging apparatuses includes the predetermined object in the imaging target area. The images held in the image holding unit 1 may be the plurality of captured images themselves, or may be images obtained through image processing performed on the plurality of captured images.

The information holding unit 2 holds information regarding an imaging target. Specifically, the information holding unit 2 holds three-dimensional model information (hereinafter, a “background model”) about an object as a background (a background object) in a virtual viewpoint image, such as the stage of a concert hall, the field of a stadium, or an auditorium. The information holding unit 2 further holds three-dimensional model information about each foreground object in a natural state, including feature information necessary for the individual recognition or the orientation recognition of the foreground object, and three-dimensional spatial information indicating the range where virtual viewpoints can be set. The natural state refers to the state where the surface of the foreground object is the easiest to look at. For example, if the foreground object is a person, the natural state may be a standing position where the four limbs of the person are stretched. Additionally, the information holding unit 2 holds information regarding a scene related to an imaging target, such as time schedule information regarding the start of a performance and the turning of the stage, or planned events, such as a solo part and an action, or a kickoff and halftime. The information holding unit 2 may not need to hold all the above pieces of information, and may only need to hold at least any of the above pieces of information.

The information processing apparatus 3 includes a virtual viewpoint image generation unit 301 (hereinafter, an “image generation unit 301”), a virtual camera path calculation unit 302 (hereinafter, a “path calculation unit 302”), and a virtual camera information analysis unit 303 (hereinafter, an “analysis unit 303”). The information processing apparatus 3 further includes a presentation information generation unit 304 (hereinafter, an “information generation unit 304”), an information display unit 305, a user information management unit 306 (hereinafter, an “information management unit 306”), and an apparatus communication unit 307.

The image generation unit 301 generates three-dimensional model information (hereinafter, “foreground model”) for the foreground object(s) based on the multi-viewpoint images obtained from the image holding unit 1. Then, the image generation unit 301 performs, for the generated foreground models and the background model obtained from the information holding unit 2, mapping on texture images in correspondence with virtual camera paths obtained from the path calculation unit 302. The image generation unit 301 then performs rendering, thereby generating the virtual viewpoint image. The virtual viewpoint image to be generated corresponds to the virtual camera paths and is transmitted to the user terminals 4 via the apparatus communication unit 307. In this generation process, with reference to the feature information about the foreground objects held in the information holding unit 2, the image generation unit 301 identifies the foreground objects and associates individual identifications (IDs) (hereinafter, “foreground object IDs”) of the foreground objects with the foreground models. Alternatively, the user of the image processing system 100 may visually identifies the generated foreground models and manually associate the foreground object IDs with the foreground models. The image generation unit 301 generates subject element information regarding foreground elements included in the virtual viewpoint image based on the feature information about the foreground objects. The foreground elements refer to elements (parts) included in a certain foreground object. For example, if the foreground object is a person, the foreground elements are the parts of the person, such as the front of the face, the back of the face, the front of the torso, the back, and the right arm. Then, the subject element information includes information indicating IDs (hereinafter, “foreground element IDs”), the positions, and the orientation of the foreground elements included in the virtual viewpoint image to be created (to be captured by virtual cameras). The image generation unit 301 transfers the foreground object IDs and the subject element information to the analysis unit 303.

The path calculation unit 302 obtains temporally continuous virtual camera information (viewpoint information) based on instruction information corresponding to a user operation on the path indication unit 403 of each user terminal 4, or information obtained from the analysis unit 303. The path calculation unit 302 then sets virtual camera paths that are the movement paths of virtual cameras corresponding to the virtual viewpoint image to be generated. The virtual camera information includes the position and the orientation of each virtual camera (each virtual viewpoint). The virtual camera information may further include information regarding the angle of view and the focal position of the virtual camera. Then, each piece of virtual camera information includes a frame number assigned to the multi-viewpoint images and time information associated with a time code, so that it is possible to identify (determine) to which moment of a captured scene the information corresponds. In calculating the virtual camera information, with reference to the three-dimensional spatial information obtained from the information holding unit 2, the path calculation unit 302 sets the virtual camera paths in the range where virtual viewpoints is settable.

The analysis unit 303 analyzes an attention target of users who specify the virtual camera paths based on the foreground object IDs and the subject element information received from the image generation unit 301 and the virtual camera information received from the path calculation unit 302. Examples of the attention target include a foreground object to which a plurality of users presumably pays attention, and a scene on which the lines of sight of virtual cameras of a plurality of users concentrate.

The information generation unit 304 generates information based on the analysis result of the analysis unit 303. Examples of the information generated by the information generation unit 304 include graphic data and text data, in which the analysis result is visualized in such a manner that the user can intuitively grasp the analysis result. Alternatively, the information generated by the information generation unit 304 may be, for example, a highlight image obtained through edition that satisfies many users, such as an image obtained by scenes on which the lines of sight of virtual cameras of many users concentrate being picked up. The analysis by the analysis unit 303 and the generation of the information by the information generation unit 304 will be described in detail below.

The information display unit 305 displays various types of information regarding control of the image processing system 100, information received from the user terminals 4, and presentation information generated by the information generation unit 304. The presentation information generated by the information generation unit 304 may be output to a storage unit of the information processing apparatus 3 or an external apparatus, or information obtained by the presentation information being processed later may be presented to the user. The information processing apparatus 3 may present at least a part of the information generated by the information generation unit 304 to the user, not by displaying an image via the information display unit 305, but by reproducing a sound via a loudspeaker (not illustrated).

The information management unit 306 receives user information, such as a user ID regarding a user operating each user terminal 4, from the user information transmission unit 404 of the user terminal 4 via the terminal communication unit 401 and the apparatus communication unit 307 and holds the user information. The information management unit 306 manages an image and various pieces of information, such as camera path information, transmitted and received between the information processing apparatus 3 and the user terminal 4, in such a manner that the association between the information and the user ID is held even during various processes to be performed in the information processing apparatus 3. This can implement the execution of different processes and the communication of different pieces of information with the plurality of user terminals 4.

The apparatus communication unit 307 transmits and receives image, sound, and text data to be exchanged between the information processing apparatus 3 and the user terminals 4 via a network (not illustrated), and instruction information, such as the indications of virtual camera paths to be sent from the user terminals 4 when the virtual viewpoint image is generated. According to an instruction from the information management unit 306, the apparatus communication unit 307 determines a communication partner(s) related to the transmission and reception of these pieces of information.

Each user terminal 4 includes the terminal communication unit 401, the image display unit 402, the path indication unit 403, and the user information transmission unit 404. The terminal communication unit 401 transmits and receives various pieces of information to and from the apparatus communication unit 307 of the information processing apparatus 3 as described above. The image display unit 402 displays the virtual viewpoint image and the presentation information obtained from the information processing apparatus 3.

The path indication unit 403 receives the user's operation specifying a virtual camera path and transfers instruction information based on the operation to the path calculation unit 302 of the information processing apparatus 3 via the terminal communication unit 401 and the apparatus communication unit 307. Here, the user may not necessarily need to strictly indicate all pieces of virtual camera information for the entire period of a virtual viewpoint image that the user wishes to view. For example, it is also possible to input instructions based on various standpoints in such a situation where the user wishes to view a virtual viewpoint image that pays attention to a particular singer or player, where the user wishes to view an image in a certain range around a ball, or where the user wishes to view an image of a portion where an event to which the user should pay more attention occurs. In a case where any of these instructions is input, the path indication unit 403 transmits instruction information, and the path calculation unit 302 of the information processing apparatus 3 generates virtual camera information based on the instruction. Alternatively, the path indication unit 403 may automatically specify a virtual camera path and transmit instruction information corresponding to the specification. The user information transmission unit 404 assigns the user information, such as the user ID, to information to be transmitted from the terminal communication unit 401 to the apparatus communication unit 307.

The configuration of the image processing system 100 is not limited to that illustrated in FIG. 1. For example, the image holding unit 1 or the information holding unit 2 may be included within the information processing apparatus 3. Further, the image generation unit 301 or the information display unit 305 may be included within an apparatus other than the information processing apparatus 3.

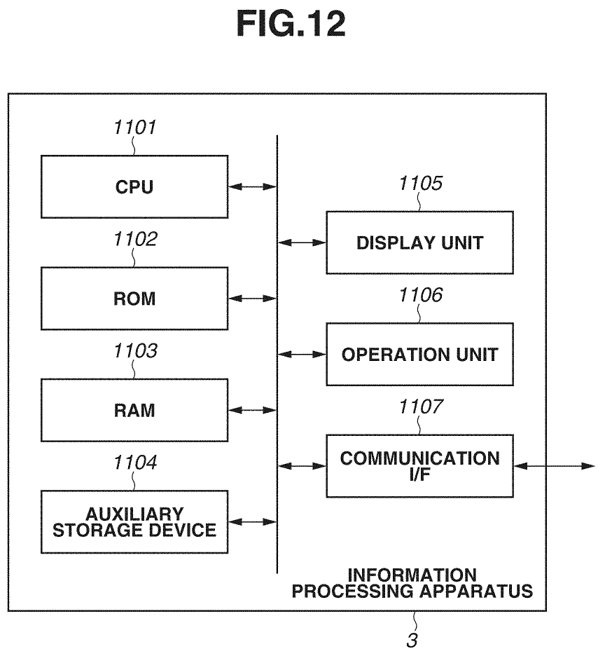

Next, with reference to FIG. 12, the hardware configuration of the information processing apparatus 3 is described. The information processing apparatus 3 includes a central processing unit (CPU) 1101, a read-only memory (ROM) 1102, a random-access memory (RAM) 1103, an auxiliary storage device 1104, a display unit 1105, an operation unit 1106, a communication interface (I/F) 1107, and a bus 1108.

The CPU 1101 controls the entirety of the information processing apparatus 3 using a computer program and data stored in the ROM 1102 or the RAM 1103.

Alternatively, the information processing apparatus 3 may include one or more dedicated hardware devices different from the CPU 1101, and the one or more dedicated hardware devices may execute at least a part of the processing of the CPU 1101. Examples of the dedicated hardware devices include an application-specific integrated circuit (ASIC), a field-programmable gate array (FPGA), and a digital signal processor (DSP). The ROM 1102 stores a program and a parameter that do not need to be changed. The RAM 1103 temporarily stores a program and data supplied from the auxiliary storage device 1104, and data supplied from outside via the communication I/F 1107. The auxiliary storage device 1104 includes, for example, a hard disk drive and stores various types of data such as image data, sound data, and virtual camera path information.

The display unit 1105 includes, for example, a liquid crystal display or a light-emitting diode (LED) and displays a graphical user interface (GUI) for the user to operate the information processing apparatus 3. The operation unit 1106 includes, for example, a keyboard, a mouse, and a touch panel. The operation unit 1106 receives an operation of the user and inputs various instructions to the CPU 1101. The communication I/F 1107 is used for communication with an external apparatus, such as each user terminal 4. In a case where, for example, the information processing apparatus 3 is connected in a wired manner to the external apparatus, a communication cable is connected to the communication I/F 1107. In a case where the information processing apparatus 3 has the function of wirelessly communicating with the external apparatus, the communication I/F 1107 includes an antenna. The bus 1108 connects the components of the information processing apparatus 3 and transmits information.

In the present exemplary embodiment, the display unit 1105 and the operation unit 1106 are provided within the information processing apparatus 3. Alternatively, the information processing apparatus 3 may not include at least one of the display unit 1105 and the operation unit 1106. Yet alternatively, at least one of the display unit 1105 and the operation unit 1106 may be provided as another apparatus outside the information processing apparatus 3, and the CPU 1101 may operate as a display control unit for controlling the display unit 1105 or an operation control unit for controlling the operation unit 1106.

### [Analysis of Attention Object]

A description is provided below of the process in which the information processing apparatus 3 causes the analysis unit 303 to analyze virtual camera information, and causes the information generation unit 304 to generate presentation information based on the analysis result, using a specific example.

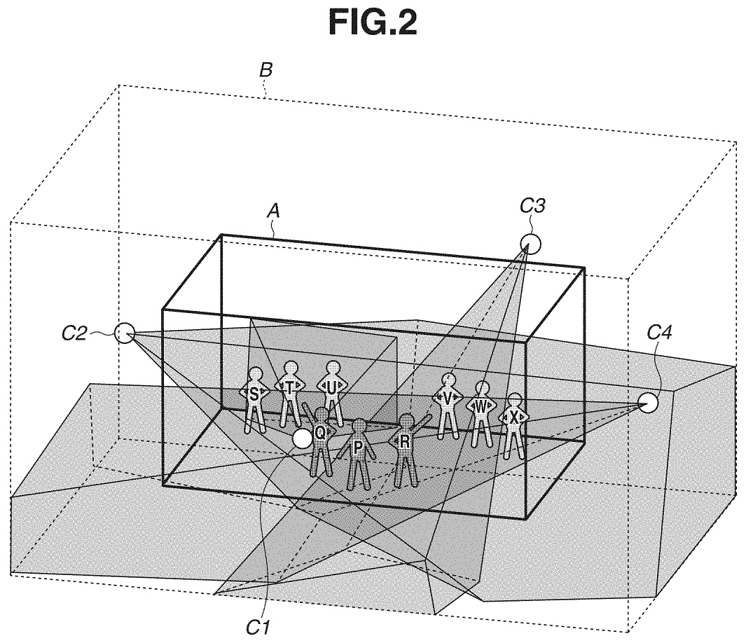

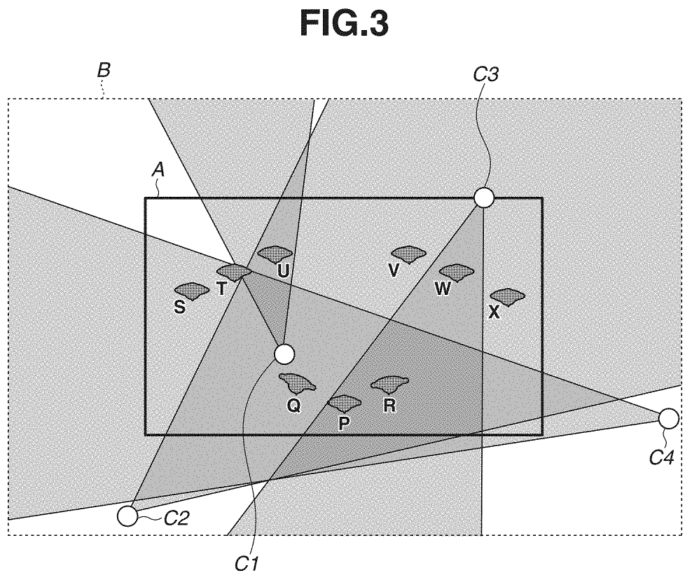

FIG. 2 illustrates fields of view of virtual cameras C1 to C4 (Cu; u=1 to 4) individually specified by four users (the user IDs are u; u=1 to 4) using the corresponding one of user terminals 4 at a certain time T during imaging. FIG. 3 is a top schematic view of FIG. 2. An area A is an analysis target area that is, in an imaging target area, a target of the analysis of virtual camera information. The area A is, for example, a three-dimensional space having a height in the range where a performance is given from a stage as an imaging target. The analysis target area may be set based on a user operation on the information processing apparatus 3, or may be set by the analysis unit 303 based on virtual camera information. An area B is the range where the virtual cameras Cu is settable. FIGS. 2 and 3 illustrate foreground objects P to X, such as singers and dancers. Here, the foreground object IDs of the foreground objects P to X are also P to X, respectively, which are the same signs as those in FIG. 3.

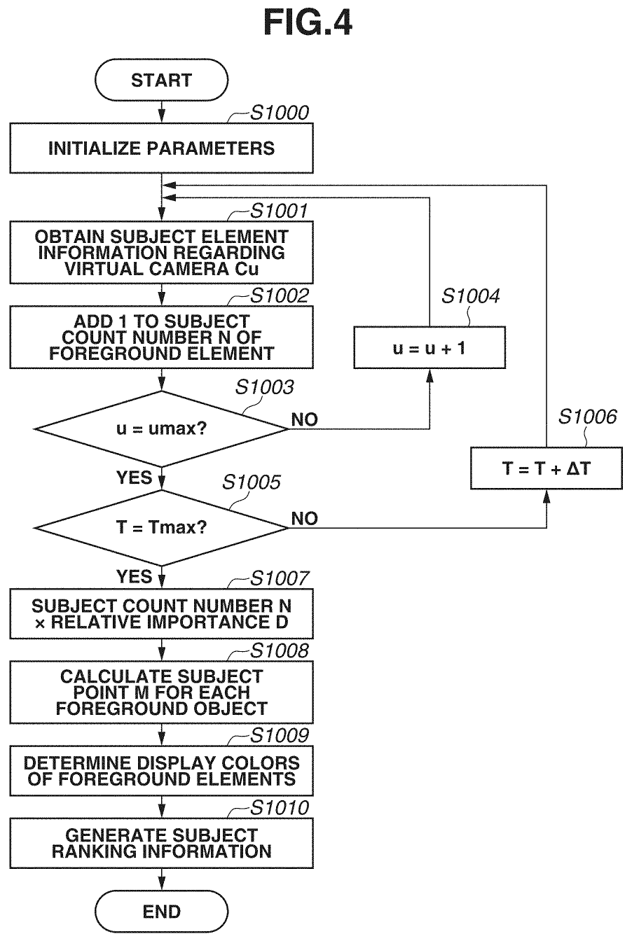

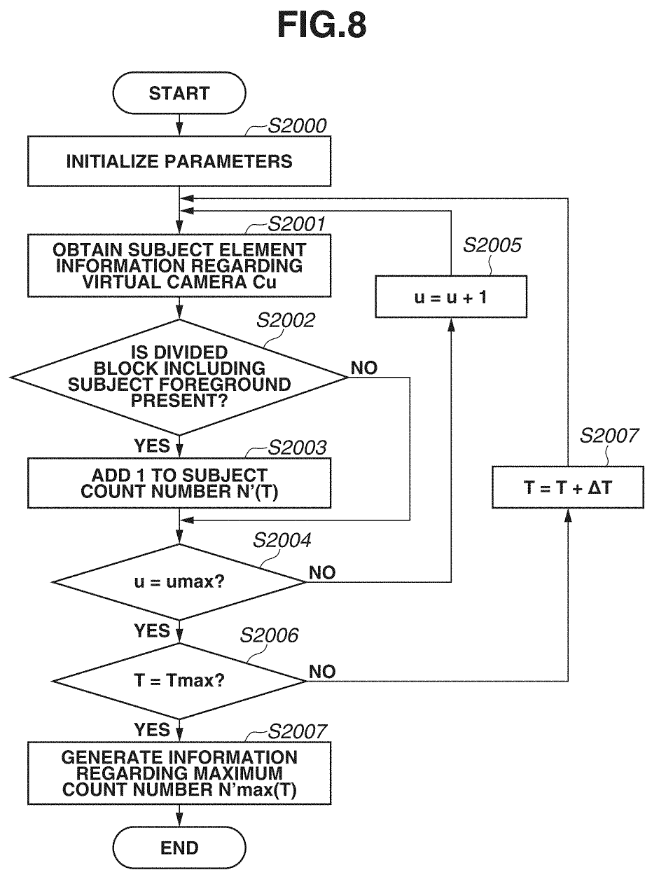

With reference to FIG. 4, a description is provided of processing regarding the analysis of virtual camera information and the generation of presentation information as illustrated in the examples of FIGS. 2 and 3. The processing illustrated in FIG. 4 is started at the timing when an instruction to analyze virtual camera information or generate presentation information is input to the information processing apparatus 3. This instruction may be provided with a user operation performed on the information processing apparatus 3, or may be input from a user terminal(s) 4. The start timing of the processing illustrated in FIG. 4, however, is not limited to this. The processing illustrated in FIG. 4 is implemented by the CPU 1101 loading a program stored in the ROM 1102 into the RAM 1103 and executing the program. At least a part of the processing illustrated in FIG. 4 may be implemented by one or more dedicated hardware devices different from the CPU 1101. The same applies to processing illustrated in a flowchart in FIG. 8 (described below).

First, in step S1000, various parameters used for the processing in FIG. 4 are initialized. More specifically, the number of virtual cameras Cu (umax) as targets of the analysis and an imaging period (Tmax) as a target of the analysis are set, one of the virtual cameras Cu as the analysis targets is selected (u=1), and the start time of the imaging period as the target is specified (T=0). The virtual cameras Cu as the analysis target and the period as the analysis target may be determined based on an operation of the user, or may be automatically determined. For example, regarding the virtual cameras Cu, all virtual cameras specified by the user terminals 4 connected to the information processing apparatus 3 when the analysis is performed may be determined as the analysis targets, or virtual cameras specified by the user terminals 4 connected to the information processing apparatus 3 in the past may be determined as the analysis targets. The information processing apparatus 3 may determine, as the analysis targets, virtual cameras corresponding to a user(s) having particular attributes based on information managed by the information management unit 306.

In step S1001, the analysis unit 303 obtains from the image generation unit 301 the foreground object ID and subject element information about a foreground object included in the field of view of the selected virtual camera Cu at the specified time T. In step S1002, the analysis unit 303 adds one to a subject count number N (the initial value in step S1000 is zero) assigned to a foreground element corresponding to the subject element information (a foreground element included in the field of view of the virtual camera Cu). To determine which foreground object is included in the field of view of the virtual camera Cu, the result of the determination made when the image generation unit 301 generates a virtual viewpoint image in correspondence with the virtual camera Cu can be used. However, a method for detecting a foreground object included in the field of view of the virtual camera Cu is not limited to this. Alternatively, the analysis unit 303 may make the determination based on position information about one or more foreground objects obtained based on multi-viewpoint images, and virtual camera information obtained by the path calculation unit 302. Yet alternatively, the analysis unit 303 may analyze a virtual viewpoint image generated by the image generation unit 301 and corresponding to the virtual camera Cu, thereby determining an object included in the virtual viewpoint image, i.e., an object included in the field of view of the virtual camera Cu.

In step S1003, the analysis unit 303 determines whether the processes of steps S1001 and S1002 are performed on all the virtual cameras Cu as the targets of the analysis (whether u=umax). If there is a virtual camera Cu that has not yet been processed (NO in step S1003), the processing proceeds to step S1004. In step S1004, another virtual camera Cu is selected (u=u+1), and the processing returns to step S1001. In this manner, the above-described subject counting in steps S1001 and S1002 is executed for all the virtual cameras Cu as the analysis targets.

In step S1005, the analysis unit 303 determines whether the processes of steps S1001 to S1004 are performed on the entire imaging period to be analyzed (whether T=Tmax). If there is a time T that has not yet been processed (NO in step S1005), the processing proceeds to step S1006. In step S1006, a next time T is specified (T=T+ΔT), and the processing returns to step S1001. In this manner, the above-described subject counting in steps S1001 to S1004 is executed for the entire imaging period to be analyzed.

As a result of the processes of steps S1001 to S1006, for each foreground element, the subject count number N proportional to the number of virtual cameras Cu of which the fields of view include the foreground element and the time T is obtained. In step S1007, the obtained subject count number N is multiplied by relative importance D. The relative importance D indicates the degree of importance of each foreground element and is optionally determined in advance. For example, in a case where the foreground object is a person, the relative importance D may be determined such that the closer to the face the foreground element (the body part) is, the greater the relative importance D. In step S1008, for each foreground object, the analysis unit 303 totals the weighted count numbers N x D of a plurality of foreground elements included in the foreground object. This total result END is a subject point M indicating the degree of attention to the foreground object.

Next, in step S1009, the information generation unit 304 determines a display method for displaying the foreground elements corresponding to the subject count numbers N. More specifically, in the manner of a color heat map, the display colors of the foreground elements are determined in the order of red for a foreground element having the largest subject count number N, orange, yellow, and green for intermediate subject count numbers N, and blue for a foreground element having the smallest subject count number N, in accordance with a staging rule determined in advance. The display method for displaying the foreground elements, however, is not limited to this. The display method may be any display method enabling the identification of foreground elements of which the subject count numbers N are different from each other by a certain number or more. For example, a foreground element having the subject count number N=0 may be colorless, or the magnitude of each subject count number N may be represented by shade of a single hue or difference in texture. Furthermore, on the result of the determination of the display colors of all the foreground elements, a boundary process for eliminating the boundary lines between the foreground elements may be performed so that the boundaries between the colors are smooth. Yet furthermore, the subject count number N may be displayed as it is as a numerical value near each foreground element. These representation methods may be combined together.

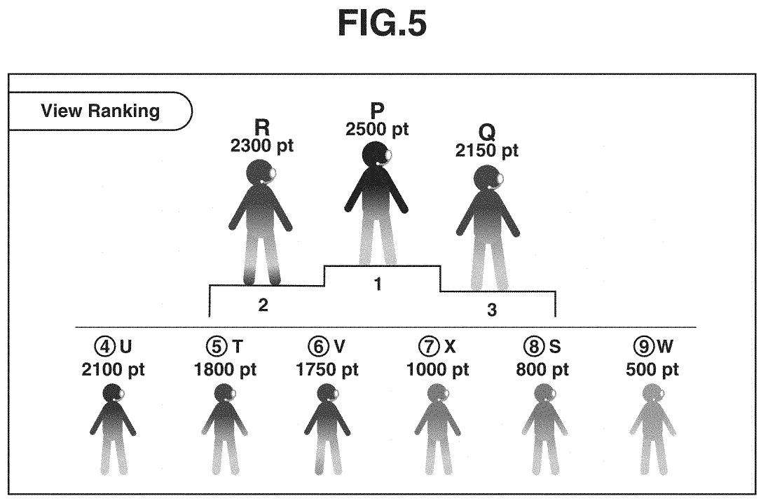

In step S1010, the information generation unit 304 generates subject ranking information. First, the information generation unit 304 applies the display colors determined in step S1009 to the natural state model of the foreground object obtained from the information holding unit 2. In this coloration, the natural state model may be translucently colored in a multi-layered manner such that the original color and design of the foreground object and the visibility of the detailed shape of the foreground object are maintained. Then, the information generation unit 304 generates an image for displaying this colored foreground object model together with graphics and text indicating a ranking in ranking order corresponding to the above-described subject point M. The generated image is displayed on the information display unit 305. FIG. 5 illustrates an example of the image displayed at this time.

In FIG. 5, for illustrative reasons, the magnitude of each subject count number N is represented by the shade of a color, and the boundaries in display are smoothly corrected. However, various variations are applicable as described above. Since the foreground object model is a three-dimensional model, the orientation of the object may be able to be freely changed. Although the natural state model of the foreground object is displayed in FIG. 5, the foreground object model at any moment, such as the foreground object model at the moment when the subject count number N of the foreground object fluctuates most, may be displayed by using the method as in FIG. 5. Such a display enables a user viewing the display to easily grasp not only to which foreground object attention is paid, but also in which scene attention is paid to the foreground object. Furthermore, information generated by the information generation unit 304 and presented to the user may only need to include information corresponding to the determination result of determining an object included in the field of view of each of a plurality of virtual cameras, and is not limited to the ranking display as in FIG. 5. For example, an image may be displayed in which foreground objects in a virtual viewpoint image of a particular scene in an imaging period are colored in correspondence with the subject count numbers N. Alternatively, numerical values corresponding to the subject count numbers N may be displayed on the virtual viewpoint image. The above-described examples of various types of presentation information is based on the number of virtual cameras Cu of which the fields of view include the same object. This enables a user to easily grasp the degree of attention to each object. The present disclosure, however, is not limited to this. Alternatively, information indicating merely whether a predetermined object is included in the field of view of any of a plurality of virtual cameras may be presented.

This is the flow regarding the analysis of virtual camera information and the presentation of information. In other words, this is the flow in which an attention target of users is analyzed by determining at which element more virtual cameras are directed and which foreground object includes the element, and the analysis result is visualized.

In the above description, if each foreground element is included in the field of view of a certain virtual camera at a certain moment, one is uniformly added to the subject count number N. The manner of counting, however, is not limited to this. The analysis unit 303 may perform counting by determining an object included in a range in the field of view corresponding to the position and the orientation of a virtual camera identified (determined) based on virtual camera information. This range in the field of view of the virtual camera is not limited to a range corresponding to the field of view of the virtual camera (the range of a virtual viewpoint image corresponding to the virtual camera). For example, a value may be added to the subject count of an object included in a part of a range corresponding to the field of view of the virtual camera, such as a predetermined range in the field of view of the virtual camera and close to the center of the field of view, and a value may not be added to the subject count of an object included outside the predetermined range. Additionally, based on the position or the orientation of a foreground element, a value to be added to the subject count number N may be other than one. For example, a value may be added to the subject count number N of a foreground element such that the closer to the front of the foreground element the orientation of the virtual camera is, i.e., as the direction vector of the virtual camera and the direction vector of the foreground element confront directly, the value to be added increases. Alternatively, a value may be added to the subject count number N of a foreground element such that the closer to the virtual camera the position of the foreground element is, the greater the value. Yet alternatively, a value may be added to the subject count number N of a foreground element such that the closer to the center of the field of view of the virtual camera the position of the foreground element is, or the closer to the focused position of the virtual camera the position of the foreground element is, the greater the value. Additionally, in a case where the user does not indicate specific virtual camera information, but provides an instruction indicating that the user wishes to view a virtual viewpoint image in which attention is paid to a particular foreground object, a particularly great value may be added to the subject count number N of the foreground object. In this way, the user's clear intention of viewing the particular foreground object can be reflected on the analysis result. While some addition rules of the subject count number N have been described above, the present disclosure is not limited to these. Alternatively, a plurality of addition rules may be combined together.

In the above description, the subject count number N is calculated for each part of a foreground object (for each foreground element), and information is displayed such that the degree of attention to each part can be grasped. The present disclosure, however, is not limited to this. Alternatively, the entirety of a foreground object may be uniformly colored based on the subject point M of the foreground object. Yet alternatively, coloration may not be performed, and the subject point M of each foreground object and information based on the subject point M may be simply displayed as text. In a case where each foreground element is not color-coded, the subject count number N in the processing illustrated in FIG. 4 may also be calculated for each foreground object. For example, in a case where a person is included in the imaging target area, then instead of performing counting by determining whether the parts of the person are included in the field of view of a virtual camera, counting may be performed by determining whether the person is included in the field of view of the virtual camera. If counting is thus performed for each object, it is possible to reduce the processing amount as compared with a case where counting is performed for each foreground element. The information processing apparatus 3 may switch the above various display methods based on an instruction given by the user and input to the information processing apparatus 3, or the attribute of the user.

### [Analysis of Attention Scene]

In the above description, an example has been described where an object to which many users pay more attention than other objects is identified (determined) through an analysis, and information enabling the identification of the attention object is presented. In contrast, a description is provided below of an example where the time when the lines of sights of many virtual cameras concentrate on a certain range, i.e., a scene to which many users pay more attention, is identified (determined) through an analysis, and information enabling the identification of the attention scene is presented. In the following description, processes and targets similar to those in the above processing flow regarding the analysis of an attention object are designated by the same signs, and are not described.

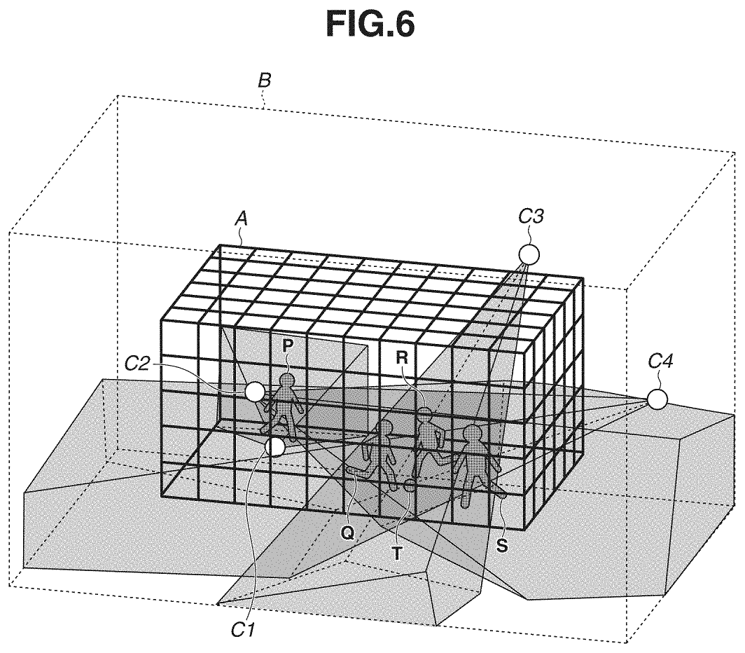

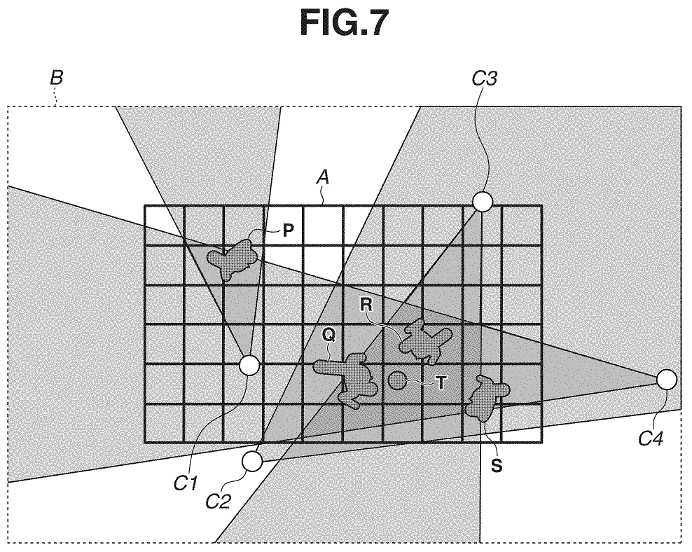

FIG. 6 illustrates the fields of view of virtual cameras C1 to C4 (Cu; u=1 to 4) individually specified by four users (the user IDs are u; u=1 to 4) using the user terminals 4 at a certain time T during imaging. FIG. 7 is a top schematic view of FIG. 6. FIGS. 6 and 7 are different from FIGS. 2 and 3 in that an area A as an analysis target area in FIGS. 6 and 7 is divided into a predetermined number of blocks in three directions in a three-dimensional coordinate system XYZ. In the following description, divided blocks refer to the blocks into which the area A is divided. The sizes and the number of divided blocks are set in advance in the information processing apparatus 3, but may be set based on a user operation.

With reference to FIG. 8, a description is provided of a processing flow regarding the analysis of virtual camera information and the generation of presentation information as illustrated in the examples of FIGS. 6 and 7. The start timing of the processing illustrated in FIG. 8 is similar to that in FIG. 4. The differences from FIG. 4 are mainly described below.

First, in step S2000, various parameters to be used for the processing in FIG. 8 are initialized. In step S2001, the analysis unit 303 obtains, from the image generation unit 301, subject element information regarding a foreground element of a foreground object included in the field of view of the virtual camera Cu. In step S2002, the analysis unit 303 determines whether a divided block including at least a part of the foreground element corresponding to the subject element information (the foreground element included in the field of view of the virtual camera Cu) is present. If the corresponding divided block is present (YES in step S2002), then in step S2003, the analysis unit 303 adds one to a subject count number N′(T) (the initial value in step S2000 is zero) at the time T assigned to the divided block. If the corresponding divided block is not present in step S2002 (NO in step S2002), the process of step S2003 is not performed, and the processing proceeds to step S2004.

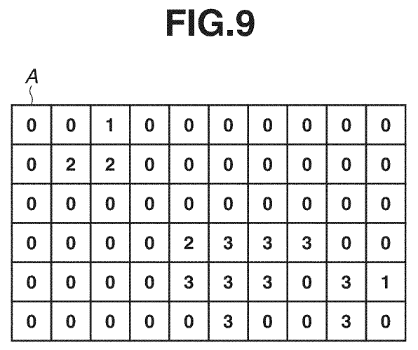

Via the processes from steps S2004 to S2005, the above subject counting is executed on all the virtual cameras Cu as the targets of the analysis. As a result, for each divided block, the subject count number N′(T) corresponding to the number of virtual cameras Cu of which the fields of view include the divided block is obtained. FIG. 9 illustrates examples of the subject count numbers N′(T) of the divided blocks at the certain time T. While FIG. 9 illustrates the count numbers in a top schematic view similar to that in FIG. 7 for ease of description, in practical, subject counting is performed on each of the divided blocks in a three-dimensional space as illustrated in FIG. 6. Then, via steps S2006 and S2007, such subject counting is performed on each divided block for each time T included in the imaging period (T=0 to Tmax) as the analysis target.

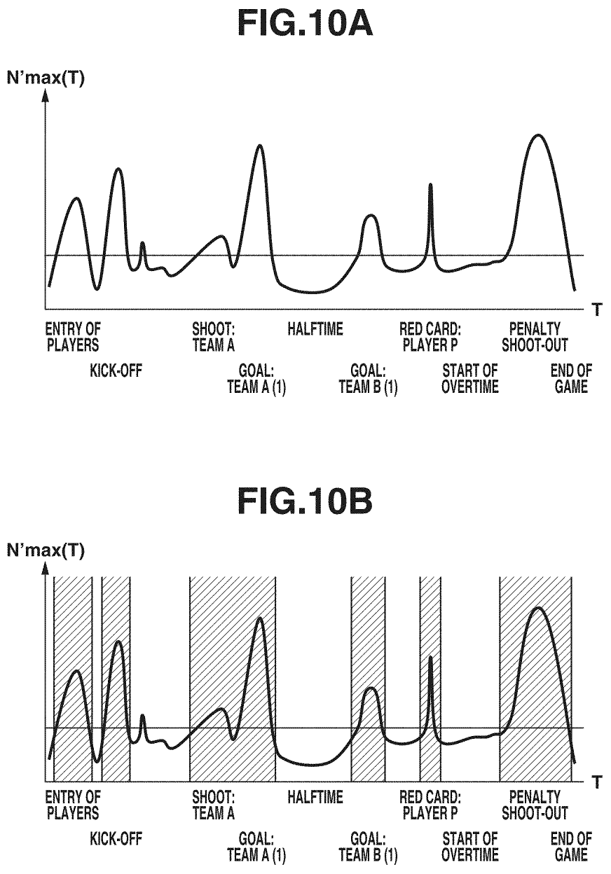

In step S2008, the information generation unit 304 identifies (determines), from the subject count numbers N′(T) of the blocks at each time T calculated by the analysis unit 303, a maximum count number N′max(T), which is a maximum value of the subject count numbers N′(T) at the time T. In other words, the maximum count number N′max(T) is the subject count number N′(T) of a divided block on which the viewpoints of most virtual cameras Cu concentrate at the time T. Then, the information generation unit 304 generates information with the maximum count number N′ max(T) being plotted on a graph of which the horizontal axis is the time T. At this time, the information generation unit 304 may add to the time axis an event that occurs during imaging, such as a shoot or a goal, or a time schedule obtained from the information holding unit 2, such as a kickoff and halftime. The generated image is displayed on the information display unit 305. FIG. 10A illustrates an example of the displayed image.

In FIG. 10A, the calculated maximum count number N′ max(T), a line indicating a threshold for the maximum count number N′ max(T), and information regarding the time of the occurrence of an event are displayed. The information regarding the time of the occurrence of each event may be manually input after imaging, or may be created by a scene being automatically determined from an image obtained by imaging.

Alternatively, the threshold for the maximum count number N′ max(T) may be manually set by a user operation, or may be automatically set. For example, the threshold may be set based on the average value of the maximum count numbers N′ max(T) in the entire imaging period as the target. Moreover, the information generated by the information generation unit 304 may be not only the example of FIG. 10A, where a smooth line connects the maximum count numbers N′ max(T) at the respective times, but also any information regarding the time or the period when a region of interest included in a range in the fields of view of a plurality of virtual cameras is present. For example, the information generated by the information generation unit 304 may be in the form of a point graph or a bar graph, or may be in the form in which a numerical value indicating the degree of attention at each time is displayed as text. For yet another example, the magnitude of the degree of attention may be represented with a time axis bar having a certain width being colored in the manner of a color heat map, or coloration may be combined with the above-described other representations.

The information generated by the information generation unit 304 may not need to indicate the maximum count numbers N′ max(T) at all times. For example, the information generated by the information generation unit 304 may only need to include information indicating one or more times or periods in the imaging period, such as the time or the period when the maximum count number N′ max(T) exceeds the threshold, or the time or the period when the maximum count number N′ max(T) falls below the threshold. For yet another example, the information generated by the information generation unit 304 may indicate the time when the maximum count number N′ max(T) is the largest, or the time when the maximum count number N′ max(T) is the smallest. Furthermore, in a virtual viewpoint image of a particular scene in the imaging period, information indicating whether the scene has a high degree of attention (whether the maximum count number N′ max(T) exceeds the threshold) or a numerical value corresponding to the maximum count number N′ max(T) may be displayed.

This is the flow for the analysis of virtual camera information and the presentation of information. That is, this is the flow in which an attention target of users is analyzed through determination of which element more virtual cameras are directed at and which foreground object includes the element, and the analysis result is visualized.

As in the above description regarding the analysis of an attention object, the analysis unit 303 may make a determination on an object not only included in the entire field of view of a virtual camera, but also an object included in a range corresponding to the position and the orientation of the virtual camera to perform counting. A value to be added to each count may not be uniform. In the above description with reference to FIG. 8, a foreground element included in the fields of view of virtual cameras is identified (determined), and subject counting is performed on each divided block based on the identified foreground element. However, the counting may be performed not on each foreground element, but on each foreground object. In other words, a foreground object included in the fields of view of virtual cameras may be identified (determined), and a value may be added to the subject count number of a divided block including at least a part of the foreground object.

The analysis unit 303 may simply add a value to the subject count number of a divided block included in the fields of view of virtual cameras, regardless of the position of a foreground object. In other words, the analysis unit 303 may perform determination on an area included in the field of view of each of a plurality of virtual cameras among an area included in at least any of the imaging ranges of a plurality of imaging apparatuses, to perform counting. On the basis of the determination result of the analysis unit 303, the information generation unit 304 may generate information indicating one or more times included in the imaging period and determined based on the number of virtual cameras of which the fields of view overlap each other. With this method, for example, it is possible to generate information indicating the time when the same area is included in the fields of view of as many virtual cameras as or more virtual cameras than a threshold, i.e., information indicating the time when the lines of sights of many virtual cameras concentrate on the same region of interest. The position of a foreground object does not need to be determined with this method. Thus, it is possible to generate the information with a small processing amount. The above threshold may be a value set in advance in the information processing apparatus 3 based on, for example, a user operation, or may be a value determined based on a determination result of the analysis unit 303, such as a value based on the average value of the number of cameras of which the fields of view overlap each other in the imaging period. Automatic determination of the threshold based on the determination result can save the trouble of manually setting the threshold in a case where the number of virtual cameras as targets of subject determination changes.

On the other hand, using the method for performing subject counting on a divided block corresponding to a predetermined object as described with reference to FIG. 8 enables the information generation unit 304 to generate information indicating the time when the lines of sights of a plurality of imaging apparatuses concentrate on the same object. Thus, it is less likely to identify (determine), as an attention scene, the time when an area where a foreground object is not present and to which attention is not particularly paid enters the fields of view of many virtual cameras by accident. Thus, it is possible to present information further matching the actual degree of attention.

### [Generation of Highlight Image]

In the above description, an example has been described where an object or a scene as a target to which a plurality of users who specifies virtual cameras pays more attention is identified (determined), and information enabling the identification of the attention target is presented. A method for using the result of identifying the attention target, however, is not limited to the presentation of the above information. A description is provided below of an example where a highlight image is generated using the result of identifying the attention target.

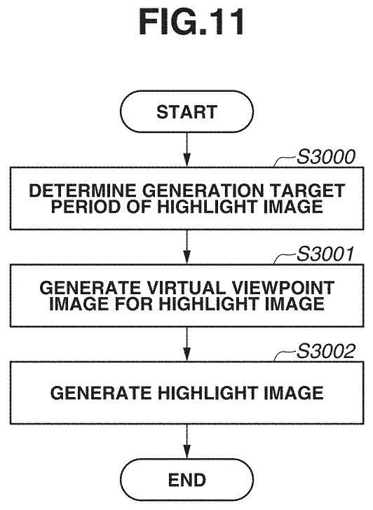

With reference to FIG. 11, a description is provided of a processing regarding the generation of a highlight image by using the information processing apparatus 3. The processing illustrated in FIG. 11 is started at the time when an instruction to generate a highlight image is input to the information processing apparatus 3 after the processing illustrated in FIG. 8 ends. This instruction may be provided with a user operation to be performed on the information processing apparatus 3, or may be input from each user terminal 4. The start timing of the processing illustrated in FIG. 11, however, is not limited to this.

In step S3000, the analysis unit 303 determines a period as a generation target of a highlight image in the period when imaging is performed based on the information generated in the processing in FIG. 8, such as the calculated maximum count number N′ max(T). More specifically, the analysis unit 303 identifies a period when the maximum count number N′ max(T) exceeds a threshold N′th. The analysis unit 303 then sets the identified period as the generation target period of the highlight image. At this time, only the period when N′th<N′ max(T) continues for a predetermined duration or more may be determined as the generation target. Alternatively, even if the period when N′th<N′ max(T) continues is short, but if the period includes a time when N′ max(T) is very large, a period including a predetermined time before and after this time may be determined as the generation target. Yet alternatively, a time T when N′th<N′ max(T) is obtained may also be appropriately included in the generation target so that each scene of the highlight image starts and ends naturally. FIG. 10B illustrates examples of the period as the generation target of the highlight image in a case where the maximum count number N′ max(T) as illustrated in FIG. 10A is obtained. In FIG. 10B, a shaded portion indicates the period identified as the generation target.

In step S3001, the image generation unit 301 generates a virtual viewpoint image corresponding to the generation target period of the highlight image, which is a partial period in the imaging period. Specifically, the analysis unit 303 generates information indicating the position of a divided block of which the subject count number N′(T) is large at each time in the generation target period determined in step S3000 (a position included in the fields of view of as many virtual cameras as or more virtual cameras than a threshold). Then, the analysis unit 303 transfers the generated information to the path calculation unit 302. The path calculation unit 302 then calculates new virtual camera paths of which the fields of view include the position of this block, and the image generation unit 301 generates a virtual viewpoint image corresponding to the calculated virtual camera paths. A method for setting the virtual camera paths corresponding to the virtual viewpoint image for the highlight image generated in step S3001 is not limited to this. For example, using the above analysis result of the attention object, the path calculation unit 302 may set virtual camera paths for image capturing from the front a foreground element of which the subject count number N is the largest or a foreground object of which the subject point M is the largest in the generation target period. Alternatively, the path calculation unit 302 may extract a portion corresponding to the generation target period from virtual camera paths specified by the user terminals 4 in the past and use the extracted portion as the virtual camera paths for generating the highlight image. In such a case, among the virtual camera paths specified in the past, the path calculation unit 302 may select a virtual camera path of which the field of view includes the attention object in the generation target period of the highlight image, and use the selected virtual camera path. As the virtual camera paths for generating the highlight image, virtual camera paths set in advance may be used.

In step S3002, the information generation unit 304 receives the virtual viewpoint image generated by the image generation unit 301 in step S3000 and generates supplementary information regarding the virtual viewpoint image. The supplementary information indicates, for example, an event corresponding to the generation target period of the highlight image, the name of a foreground object included in the virtual viewpoint image, a time schedule, and the degree of attention to a scene or an object. The information to be added, however, is not limited to this. The information generation unit 304 then generates a highlight image obtained by the virtual viewpoint image being combined with these pieces of supplementary information. Specific supplementary information to be combined with the virtual viewpoint image may be automatically determined by the information processing apparatus 3, or may be determined based on a user operation performed on the information processing apparatus 3. The information generation unit 304 may edit the generated highlight image based on a user operation. The generated and edited highlight image is displayed on the information display unit 305. The generated and edited highlight image may be transmitted to the user terminals 4.

This is the flow regarding the generation of a highlight image. In this way, the user can easily generate a highlight image including a scene to which many users pay attention, without great trouble. In the above description, the information processing apparatus 3 performs both the identification (determination) of a scene or an object as an attention target and the generation of a highlight image. The present disclosure, however, is not limited to this. Alternatively, the information processing apparatus 3 may output information regarding an attention scene or an attention object to an external apparatus, and another apparatus that obtains the information may generate a highlight image. In the above description, based on the result of determination of an attention scene through the processing illustrated in FIG. 8, the information processing apparatus 3 generates a highlight image including the attention scene. The present disclosure, however, is not limited to this. Alternatively, based on the result of determination of an attention object through the processing illustrated in FIG. 4, the information processing apparatus 3 may generate a highlight image including the attention object.

In the present exemplary embodiment, a case has been mainly described where the degree of attention of users based on the specifying of virtual cameras is analyzed for each foreground element or each divided block. Alternatively, the analysis unit 303 may combine these analyses. For example, the subject point M of each foreground object is calculated for each short time, and the changes over time of the subject point M are presented in a superimposed manner on the information illustrated in FIG. 10A, thus presenting information that enables an easy grasp of the correlation between an attention scene and an attention object.

When generating presentation information, the information generation unit 304 may categorize a user based on user information obtained from the information management unit 306 and generate presentation information based on this user category. Possible examples of the user category include various categories such as the age, the gender, the hometown, the current residence area, an empirical value and a favorite team in a particular sport, and an empirical value in the operation of a virtual camera. For example, in a case where the degree of attention with respect to each user category is displayed as the presentation information based on the user category, display with respect to each category may be able to be switched. The degrees of attention with respect to all the categories may be simultaneously displayed, while the degree of attention with respect to each category may be able to be differentiated with color-coding or the differentiation in texture. Alternatively, a user category name itself may be displayed as text together with the degree of attention.

In the present exemplary embodiment, the information processing apparatus 3 determines an attention target using a plurality of virtual camera paths corresponding to a plurality of users. In other words, a plurality of virtual viewpoints identified (determined) based on virtual camera information used to determine the attention target includes a plurality of virtual viewpoints corresponding to a plurality of users and also includes a plurality of virtual viewpoints corresponding to a plurality of different times. The present disclosure, however, is not limited to this. Alternatively, the information processing apparatus 3 may determine an object or an area to which the user pays attention for a long time based on a virtual camera path corresponding to a single user. Yet alternatively, based on a plurality of virtual viewpoints corresponding to a plurality of users at a certain single time, the information processing apparatus 3 may determine an object or an area to which many users pay attention at this time.

As described above, the information processing apparatus 3 according to the present exemplary embodiment obtains virtual camera information regarding virtual cameras corresponding to a virtual viewpoint image generated based on a plurality of captured images obtained by a plurality of imaging apparatuses. The information processing apparatus 3 determines an object included in at least any of the plurality of captured images and also included in a range in the fields of view of the virtual cameras identified (determined) based on the virtual camera information. The information processing apparatus 3 presents information based on the result of the determination regarding a plurality of virtual cameras identified (determined) with the use of a plurality of pieces of virtual camera information. According to a configuration as described above, it is possible to easily identify (determine) an attention target of users who specify virtual cameras regarding a virtual viewpoint image.

According to the above exemplary embodiments, it is possible to easily identify (determine) an attention target of users who specify virtual viewpoints regarding a virtual viewpoint image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-Ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2018-090314, filed May 9, 2018, which is hereby incorporated by reference herein in its entirety.

1. An information processing apparatus comprising:
an obtaining unit configured to obtain viewpoint information regarding virtual viewpoints corresponding to virtual viewpoint images generated based on a plurality of captured images obtained by a plurality of imaging apparatuses performing image capturing from a plurality of directions;
a detection unit configured to detect an object included in at least any of the plurality of captured images and included in a field of view corresponding to a virtual viewpoint identified based on the viewpoint information obtained by the obtaining unit; and
an output unit configured to, based on a detection result of the detection unit associated with a plurality of virtual viewpoints identified based on the viewpoint information obtained by the obtaining unit, output information associated with the number of virtual viewpoints of which the fields of view include a same object.

2. The information processing apparatus according to claim 1, wherein, based on position information regarding one or more predetermined objects included in at least any of the plurality of captured images, and the viewpoint information obtained by the obtaining unit, the detection unit detects the object in the fields of view of the virtual viewpoints.

3. The information processing apparatus according to claim 1, wherein, based on a virtual viewpoint image corresponding to the virtual viewpoints identified based on the viewpoint information obtained by the obtaining unit, the detection unit detects the object in the fields of view of the virtual viewpoints.

4. The information processing apparatus according to claim 1, wherein the object to be detected by the detection unit is a person or a part of a person.

5. The information processing apparatus according to claim 1, wherein the detection unit detects the object located in a predetermined portion in a range corresponding to the fields of view corresponding to the virtual viewpoints identified based on the viewpoint information.

6. The information processing apparatus according to claim 1, wherein the output unit outputs the information associated with the number of virtual viewpoints of which the fields of view include the same object among a plurality of virtual viewpoints corresponding to a plurality of users and corresponding to a same time.

7. The information processing apparatus according to claim 1, wherein the output unit outputs the information associated with the number of virtual viewpoints of which the fields of view include the same object among a plurality of virtual viewpoints corresponding to a plurality of different times.

8. An information processing apparatus comprising:
an obtaining unit configured to obtain viewpoint information regarding virtual viewpoints corresponding to virtual viewpoint images generated based on a plurality of captured images obtained by a plurality of imaging apparatuses performing image capturing from a plurality of directions;
a detection unit configured to detect an area included in at least any of imaging ranges of the plurality of imaging apparatuses and included in a field of view corresponding to a virtual viewpoint identified based on the viewpoint information obtained by the obtaining unit; and
an output unit configured to, based on a detection result of the detection unit associated with a plurality of virtual viewpoints identified based on the viewpoint information obtained by the obtaining unit, output information indicating one or more times or periods when a region of interest included in the plurality of fields of view corresponding to the plurality of virtual viewpoints is present, wherein the one or more periods are in an imaging period of the plurality of imaging apparatuses.

9. The information processing apparatus according to claim 8, wherein the information output from the output unit includes information for identifying a time or a period when a same region of interest included in at least any of the imaging ranges of the plurality of imaging apparatuses is included in the fields of view of as many virtual viewpoints as or more virtual viewpoints than a threshold.

10. The information processing apparatus according to claim 9, wherein the threshold includes a value determined in advance or a value determined based on the detection result of the detection unit.

11. The information processing apparatus according to claim 8 further comprising an image generation unit configured to, based on the information output from the output unit, generate a virtual viewpoint image corresponding to a partial period included in the imaging period and identified based on the information.

12. The information processing apparatus according to claim 9 further comprising an image generation unit configured to, based on the information output from the output unit, generate a virtual viewpoint image corresponding to a partial period included in the imaging period and identified based on the information, the virtual viewpoint image including an image of an area included in the fields of view of as many virtual viewpoints as or more virtual viewpoints than the threshold.

13. The information processing apparatus according to claim 8, wherein the output unit outputs information indicating a time or a period when the region of interest is present, and an event corresponding to the time or the period.

14. The information processing apparatus according to claim 8, wherein the detection unit detects an area included in a predetermined portion in a range corresponding to the fields of view corresponding to the virtual viewpoints identified based on the viewpoint information.

15. The information processing apparatus according to claim 8, wherein the output unit outputs information regarding a time or a period when a region of interest included in a plurality of fields of view corresponding to a plurality of virtual viewpoints corresponding to a plurality of users and corresponding to the same time is present.

16. The information processing apparatus according to claim 8, wherein the output unit outputs information regarding a time or a period when a region of interest included in a plurality of fields of view corresponding to a plurality of virtual viewpoints corresponding to a plurality of different times is present.

17. An information processing method comprising:
obtaining viewpoint information regarding virtual viewpoints corresponding to virtual viewpoint images generated based on a plurality of captured images obtained by a plurality of imaging apparatuses performing image capturing from a plurality of directions;
detecting an object included in at least any of the plurality of captured images and included in fields of view corresponding to a virtual viewpoint identified based on the obtained viewpoint information; and
outputting, based on a result of the detecting associated with a plurality of virtual viewpoints identified based on the obtained viewpoint information, information associated with the number of virtual viewpoints of which the fields of view include a same object.

18. An information processing method comprising:
obtaining viewpoint information regarding virtual viewpoints corresponding to virtual viewpoint images generated based on a plurality of captured images obtained by a plurality of imaging apparatuses performing image capturing from a plurality of directions;
detecting an area included in at least any of imaging ranges of the plurality of imaging apparatuses and included in a field of view corresponding to a virtual viewpoint identified based on the obtained viewpoint information; and
outputting, based on a result of the detecting associated with a plurality of virtual viewpoints identified based on the obtained viewpoint information, information indicating one or more times or periods when a region of interest included in the plurality of fields of view corresponding to the plurality of virtual viewpoints is present, wherein the one or more periods are in an imaging period of the plurality of imaging apparatuses.

19. A non-transitory storage medium that stores a program for causing a computer to execute an information processing method comprising:
obtaining viewpoint information regarding virtual viewpoints corresponding to virtual viewpoint images generated based on a plurality of captured images obtained by a plurality of imaging apparatuses performing image capturing from a plurality of directions;
detecting an object included in at least any of the plurality of captured images and included in a field of view corresponding to a virtual viewpoints identified based on the obtained viewpoint information; and
outputting, based on a result of the detecting associated with a plurality of virtual viewpoints identified based on the obtained viewpoint information, information associated with the number of virtual viewpoints of which the fields of view include a same object.

20. A non-transitory storage medium that stores a program for causing a computer to execute an information processing method comprising:
obtaining viewpoint information regarding virtual viewpoints corresponding to virtual viewpoint images generated based on a plurality of captured images obtained by a plurality of imaging apparatuses performing image capturing from a plurality of directions;
detecting an area included in at least any of imaging ranges of the plurality of imaging apparatuses and included in a field of view corresponding to a virtual viewpoint identified based on the obtained viewpoint information; and
outputting, based on a result of the detecting associated with a plurality of virtual viewpoints identified based on the obtained viewpoint information, information indicating one or more times or periods when a region of interest included in the plurality of fields of view corresponding to the plurality of virtual viewpoints is present, wherein the one or more periods are in an imaging period of the plurality of imaging apparatuses.
